(19) United States
(12) Patent Application Publication
(10) Pub. No.: US 2012/0215615 A1
(43) Pub. Date: Aug. 23, 2012

(54) Conditional Partial Refund Based on Units Sold

(75) Inventor: Isaac Moredock, Neptune Beach, FL (US)

(73) Assignee: Triggerback, LLC, Lakewood, NJ (US)

(21) Appl. No.: 13/462,990

(22) Filed: May 3, 2012

Related U.S. Application Data
(63) Continuation of application No. 13/219,778, filed on Aug. 29, 2011.

(51) Int. Cl. G06Q 30/02

(52) U.S. Cl. 705/14.31; 705/14.34

(57) ABSTRACT

The disclosed technology provides a method for granting partial refunds (post-payment discounts) to purchasers of a product only if a pre-determined/pre-defined number of sales has been met to purchasers signing up to be part of a partial-refund program for the product. In this manner, the purchasers have the incentive to spread information about the partial refund to their friends, such as via social networking, and “advertising” on the part of the seller, who then makes more sales. If the sales threshold is met, the partial refund is issued.

### FIELD OF THE DISCLOSED TECHNOLOGY

The disclosed technology relates generally to product discounts and, more specifically, towards granting a discount to consumers after a product has been purchased.

### BACKGROUND OF THE DISCLOSED TECHNOLOGY

The concept of a “conditional coupon” is known in the art and disclosed in U.S. Pat. No. 7,769,634 to Leung et al. (assigned to AT&T Corp.) as well as U.S. Patent Publication 2010/0287103 to Mason (assigned to Groupon, Inc.). In these references, the basic concept is that a coupon or discount is offered for a good or service. When there is a minimum number of committed purchasers associated with the coupon or offer, only then does the sale takes place. This methodology of providing consumer discounts, at the time of this writing, is flourishing in the industry, showing that a need is being fulfilled in the marketplace which is, in many ways, changing the old form of advertising a coupon and distributing it to whoever happens to want to use the coupon. Now, the consumer is given an incentive to advertise for the company by distributing the potential coupon or discount to his friends and colleagues, so that he or she can receive the discount.

Unfortunately, however, this new system of advertising is not without its drawbacks. The return on investment for such deals degrades quickly and builds little consumer loyalty. Consumers tend to look for the best deal, and then immediately run elsewhere to find the next deal. Vendors offering such promotions through a service which advertises and handles the logistics often find themselves with a short-term burst of exceptional sales at a very low price, which is a source of irritation to their regular customers who are paying full price and suddenly can't access the vendor who is overwhelmed with customers who pay very little. For example, a local ice cream store might sell a $3 ice cream cone and have 100 customers on a warm summer day. On that day, 500 additional customers might flood the store, paying $1.50 for the identical cone. The 100 regular customers, discouraged by the long waiting line, go elsewhere and find a new ice cream store; however, a week later, the additional 500 customers have moved on to the next deal, never to return to the store that had offered the promotion, or perhaps, never really having a consistent desire for ice cream in the first place. Meanwhile, the staff of the original ice cream store is likely to treat the 500 additional customers, coming in with their cheap coupons, as freeloaders, knowing full well they won't be back tomorrow. Thus, little money is being made off the transaction.

As such, the “group buying” model is unsustainable. Consumers who love these deals by small businesses are becoming increasingly ambivalent about them. Unless the initial foot traffic is smartly leveraged, and customers make repeat visits, or reputation spread by word of mouth is strong, the value of the initial frenzy is minimal and debatable. Meanwhile, the competition to offer ever better deals becomes more heated, so as to garner more traffic from conditional coupon methods.

While the methods described above have shown to be effective in getting customers inside the door and are, in some senses, a great marketing tool, improvements are needed to sustain the model. Specifically, improvements are needed which will allow for brand and consumer loyalty, as well as higher profit margins, for the vendor, while retaining the social aspect for the consumer and advertising capabilities that such systems provide.

### SUMMARY OF THE DISCLOSED TECHNOLOGY

The disclosed technology described herein addresses a need in the art to allow for group and social networking purchases while retaining customer loyalty.

Thus, it is an object of the disclosed technology to provide group purchasing discounts while retaining and encouraging customer loyalty.

It is a further object of the disclosed technology to leverage social networking to entice purchasers to advertise for the vendor or seller.

It is a further object of the disclosed technology to provide a post-payment discount, or partial refund, if enough customers purchased a product through methods and devices of the disclosed technology.

A method of issuing a partial refund to each purchaser in an opt-in group of purchasers of a product is carried out in an embodiment of the disclosed technology as follows. Hereinafter, “product” is defined as any physical item or service offered for sale in exchange for money. A pre-determined sales threshold for sales of a product to the opt-in group is determined before selling to a purchaser in the opt-in group. Further, a pre-determined partial refund amount is set. Once these conditions are determined, a first (or full) purchase price, the sales threshold, and the pre-determined partial refund amount are advertised. Then, requests are received from potential purchasers who are certified by receiving and/or acknowledging their desire to receive the advertised partial refund, after purchase of the product. The product, at the first (or full) purchase price is sold to a plurality of purchasers, and it is established whether the pre-determined sales threshold has been met. Once it has been met, the pre-determined partial refund is given in the form of a payment, refund on a payment instrument (such as a credit card), lesser charge on a payment instrument where the funds were being held or reserved, loyalty points, store credit, or the like, to each certified purchaser of the product.

In embodiments of the above method, potential purchasers may be polled to determine which product is selected for use with the method steps. The amount of the pre-determined partial refund may be based on a number of votes in the polling for a product (e.g., the more votes, the deeper the partial-refund if the product is selected). Voters, once the product is chosen for the method, may be attracted by advertisements to the selection of the product for the post-purchase partial refund, and automatically certified (meeting the criteria for certification) if they decide to purchase the product. Such purchasers may receive a bonus refund for voting on the product that was selected.

The partial refund may be to a payment instrument used to make the purchase, such as to a bank account where the funds were drawn from for a check payment (ACH processing, as is known in the art) or a credit card refund. The selling may be carried out by a first party, but the refund carried out by a third party, such as a party advertising and maintaining lists of post-purchase, partially-refundable products, and this third party may take a fee for each refund.

The sales threshold described above may be limited by any one of, or a combination of, number of sales (in dollar amount of quantity of sales) over a pre-determined period of time, an exact specification of a product brand (make) and model or service, or any product within a designated model, brand (make), style, or type of service offering, and so forth.

A product is selected for the steps of setting and selling (or any other combination of steps of the method) automatically, in an embodiment of the disclosed technology, when inventory of the product rises above a pre-defined threshold and/or when sales fall below a pre-defined threshold per unit time.

An in-store item counter with a visual display is also claimed. The in-store item counter visually exhibits the advertising described above for at least one product and further exhibits a count of how many more purchases within the opt-in group are necessary to receive said discount. For purposes of this disclosure, an “opt-in group” is defined as all purchasers who have shown explicitly or implicitly that they wish to receive the partial-refund when the requisite number of sales by others, who are also in the group, are made.)

In another embodiment, a method or system of processing refunds for a vendor of products, an advertisement (communication to a potential purchaser, purchaser, or vendor) of a partial refund for a product purchase is made if a pre-determined threshold of sales is met for the product. The threshold of sales is exhibited as part of the advertising. Each customer who purchases the product is certified (an explicit or implicit desire is communicated from the purchaser directly or via the vendor) as part of a group of purchasers qualified to receive a partial refund. Information is then received including data indicating that the pre-determined threshold of sales has been met, and the partial refund is issued to each purchaser in the group of purchasers.

The partial refund, in the above method, may be to a credit card or debit card and/or exhibited on a statement associated with the credit card or debit card as a loyalty credit, such as by including the word, “TRIGGERBACK.”

The certification may be based, at least in part, on matching identifying data of a purchaser provided by the vendor with identifying data provided to an entity carrying out the method of processing refunds, at a time before or after the purchase. Such identifying data may be a billing address and credit card number of a purchaser.

The purchase may be non-refundable if the threshold of sales is not reached and the purchaser is part of the group (to avoid purchasers that only intend to maintain their purchasing habits if the partial refund is applied).

A single non-vendor entity carries out the steps of advertising, certifying, receiving, and issuing on behalf of the vendor, in an embodiment of the disclosed technology. After the threshold of sales is reached, additional purchasers may join the group, in some embodiments, and are certified up to a pre-determined upper-limit threshold of purchasers in the group. For example, 100 purchasers may be required in order to get the partial refund, but the deal may be open for up to 200 purchasers, with purchasers 101 through 200 knowing or not knowing that the sales threshold has been met, depending on embodiment.

A system of providing partial refunds after purchase, in a further embodiment of the disclosed technology, proceeds by receiving data with the number of sales of a product to purchasers indicating a desire to receive a partial refund if the number of sales to the purchasers exceeds a pre-determined amount; determining if the number of sales to the purchasers is above the pre-determined amount; and issuing the partial refund to the purchasers.

### BRIEF DESCRIPTION OF THE DRAWINGS

FIG. 1 shows a flow chart of a method of carrying out embodiments of the disclosed technology.

FIG. 2 shows a flow chart showing a method of carrying out embodiments of the disclosed technology, including steps of determining which product to use with the method.

FIG. 3A shows a high level block diagram of the relationship between parties and devices used to carry out embodiments of the disclosed technology.

FIG. 3B shows a high level block diagram of the relationship between parties and devices once a sales threshold is met.

FIG. 4 shows an example of a product being advertised in connection with embodiments of the disclosed technology.

FIG. 5 shows a high-level block diagram of a device that may be used to carry out the disclosed technology.

### DETAILED DESCRIPTION OF EMBODIMENTS OF THE DISCLOSED TECHNOLOGY

The disclosed technology described herein provides a method for granting partial refunds (post-payment discounts) to purchasers of a product only if a pre-determined/pre-defined number of sales has been met to purchasers signing up to be part of a partial-refund program for the product. Let us say, for example, in an embodiment of the disclosed technology, a sales threshold is set for a product as well as a partial-refund amount. The product is advertised for sale at a first price (defined as “full price”) and (potential) purchasers express their desire to receive a partial refund of the product that they (are about to) purchase, knowing that such a partial refund will only be issued if a certain number of people buy the product with intent to take advantage of the partial refund. In this manner, the purchasers have the incentive to spread information about the partial refund to their friends, such as via social networking, and “advertising” on the part of the seller, who then makes more sales. If the sales threshold is met, the partial refund is issued.

Embodiments of the disclosed technology will become clearer in view of the following description of the figures.

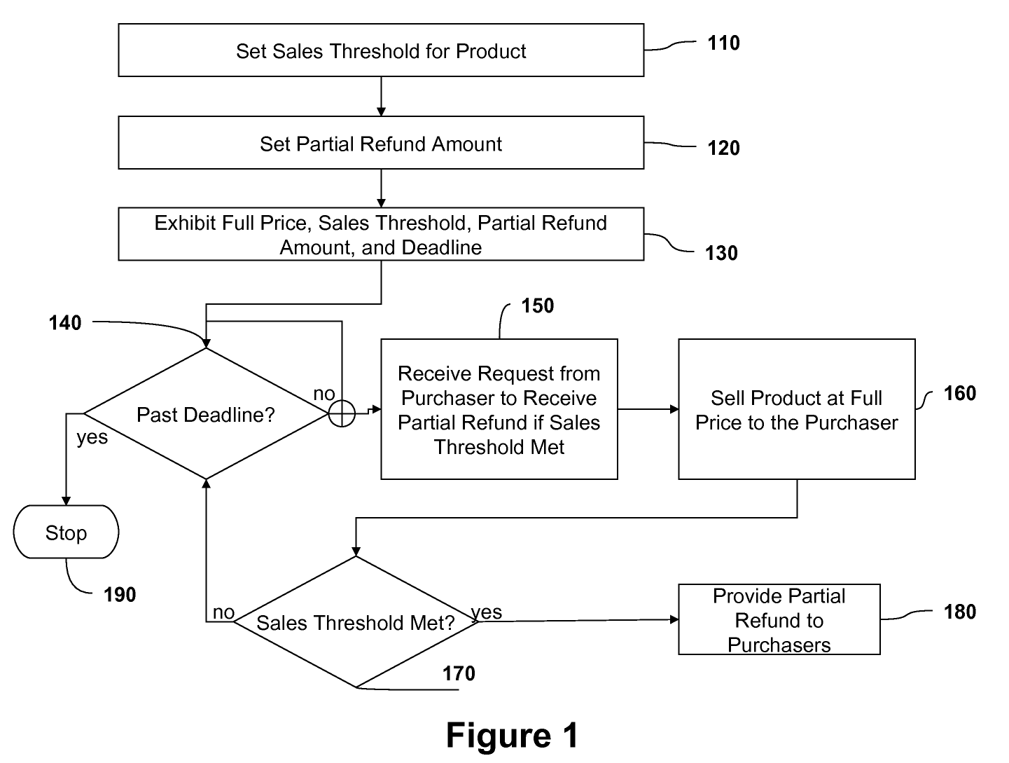

FIG. 1 shows a flow chart of a method of carrying out embodiments of the disclosed technology. In step 110, a sales threshold for a product is set. The sales threshold is defined as the number of sales of a product to users selecting to take part in a partial-refund program. The partial-refund program, in turn, is defined, for purposes of this disclosure, as a program that purchasers enter (and become certified) based on their actual purchase of a product and expressed desire to receive back a part of the purchase price if a requisite number of sales of a product offered by this program by a vendor (also used herein, “seller”) to the certified purchasers is achieved. The purchasers become certified (and counted towards the sales threshold) by expressing the desire to receive the partial refund for a product, and their purchase is counted towards the sales threshold once one of these certified purchasers makes a purchase of a product, wherein the product is available in a partial-refund program. In embodiments of the disclosed technology, the sales threshold is a quantity of sales, but in other embodiments, is instead, or also, a dollar (or other currency) amount of sales. Purchasers may be limited to one or a limited number of partial refunds per product or, in other embodiments, may be eligible for an unlimited number of partial refunds per product. A product, for purchases of this disclosure, is any good or service offering by a seller. In embodiments of the disclosed technology, a product is a specific make, model, and version of a product or a single type of service with prescribed limits, dollar amount, and lengths of time. In other embodiments, the product is any product of any model, make, style, or type of service offering.

Referring still to FIG. 1, after a sales threshold for a product is set (e.g., 100 units), in step 120, a partial refund amount is also set (e.g., $50). The full price, sales threshold, partial refund amount, and deadline to make the purchase are then advertised, as depicted in step 130. Thus, for example, a particular cellular phone may be advertised for sale at $400 (the “full price” or “first price”) with a partial refund of $50 if 100 people purchase the phone and express a desire to receive the refund when and if the 100 phones are sold before an advertised sale deadline to others also seeking the partial refund.

In step 140, it is determined whether it is past the deadline, and then the partial-refund possibility expires and the method stops in step 190. Those who have purchased already would then not receive the partial refund and are left with their purchase. In embodiments of the disclosed technology, those who have already purchased the product might not be allowed to return it for a refund, or would have to return their product minus a refund fee to prevent people from purchasing products only to return them if they didn't receive the partial refund desired because not enough others bought the product to enable such a refund.

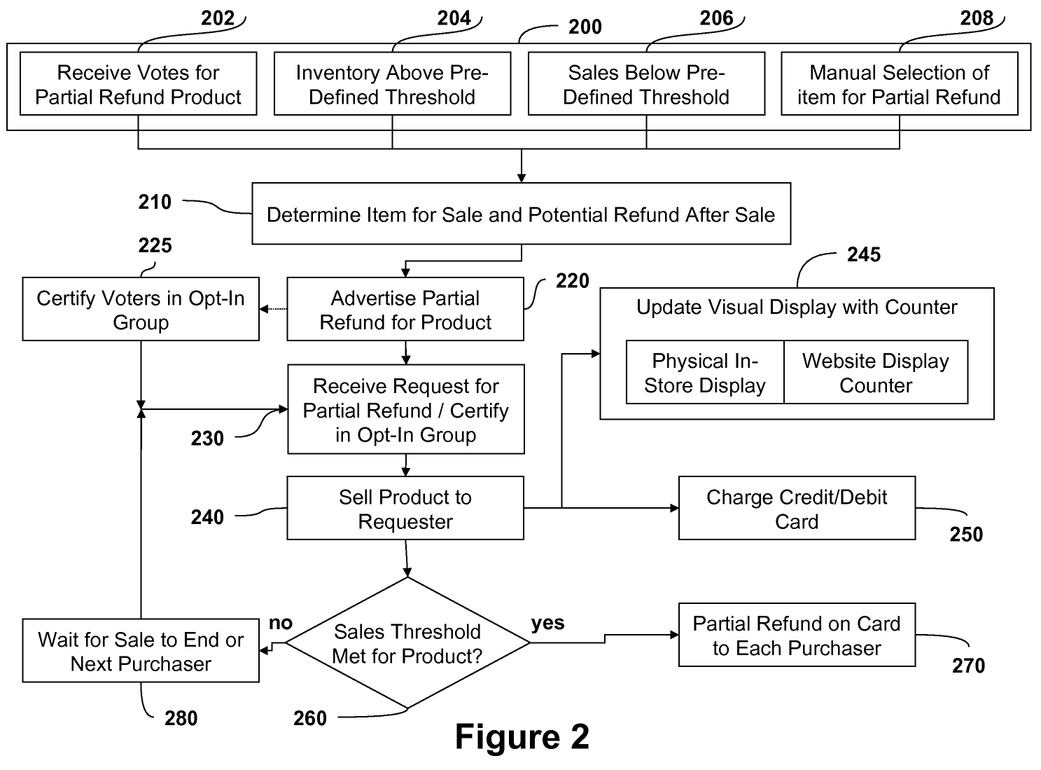

Referring still to step 140, if the deadline has not passed and purchasers may still purchase the product and be eligible to be certified into the partial-refund program based on their purchases, then step 140 is repeated until a request is received from a new purchaser in step 150. Thus, once the deadline has passed, if not enough people have made a purchase, the method stops, and those who have already purchased may be notified that they will not receive the discount, and so forth. On the other hand, while it is still before the deadline, new purchasers may be certified to receive the partial refund after their purchase. For purposes of this disclosure, “certified is defined” as joined into a class of people capable of receiving a partial refund if the sales threshold is met before the deadline based on an explicit desire by a purchaser to receive a partial refund when the sales threshold is met, or an implicit desire based on other factors, such as voting for a product (as discussed with reference to FIG. 2).

Referring now to step 150, this step involves a request from a purchaser to receive a partial refund if the pre-defined sales threshold is met (as defined in step 120 before sales are made). In embodiments of the disclosed technology, the pre-defined sales threshold may be decreased once the advertisement is made, but not increased, and still be, for purposes of this disclosure, considered part of the “pre-defined sales threshold,” such as when a vendor desires to maintain good customer relation and give the post-purchase discount anyway. Similarly, the full price of an item may change after the first advertising (such as lowering the price to keep par with the competition or decreased sourcing costs) or the partial refund amount may rise after the partial-refund program has started (but not lower, as this would place those who have already purchased at a disadvantage). Similarly, the deadline may be extended if the requisite number of sales has not been made, but not decreased in time. All of these changes are defined as being within the scope and spirit of the pre-defined refund amount, pre-defined sales threshold, and time frame. In any case, once the purchaser buys the product with a request to receive the partial refund if the sales threshold is met, in step 160, the product is sold at the full price (advertised or latest-advertised price) to the purchaser.

After each sale, the total sales are counted to determine if a sales threshold has been met, as shown in step 170. If the threshold has not been met, then step 140 is repeated. In embodiments of the disclosed technology, even if the sales threshold has been met, then step 140 is repeated up to a point, such as until a higher sales quota has been met, until a vendor decides to close the partial-refund program for a particular product (after the originally advertised and contracted deadline), or until the (originally advertised and contracted) deadline. Thus, for example, if 100 cellular phones were sold using the program, then the next 50 purchasers (for a total of 150) may still buy the phone and receive either an immediate discount (the defined partial refund amount of step 130) off the purchase price, or will also receive the partial refund. A vendor may choose to do this to encourage more sales, or may alternatively decide that closing the program at a specific number of sales will result in more money from a higher net gain per each future sale and/or greater desire in the future for purchasers to buy sooner.

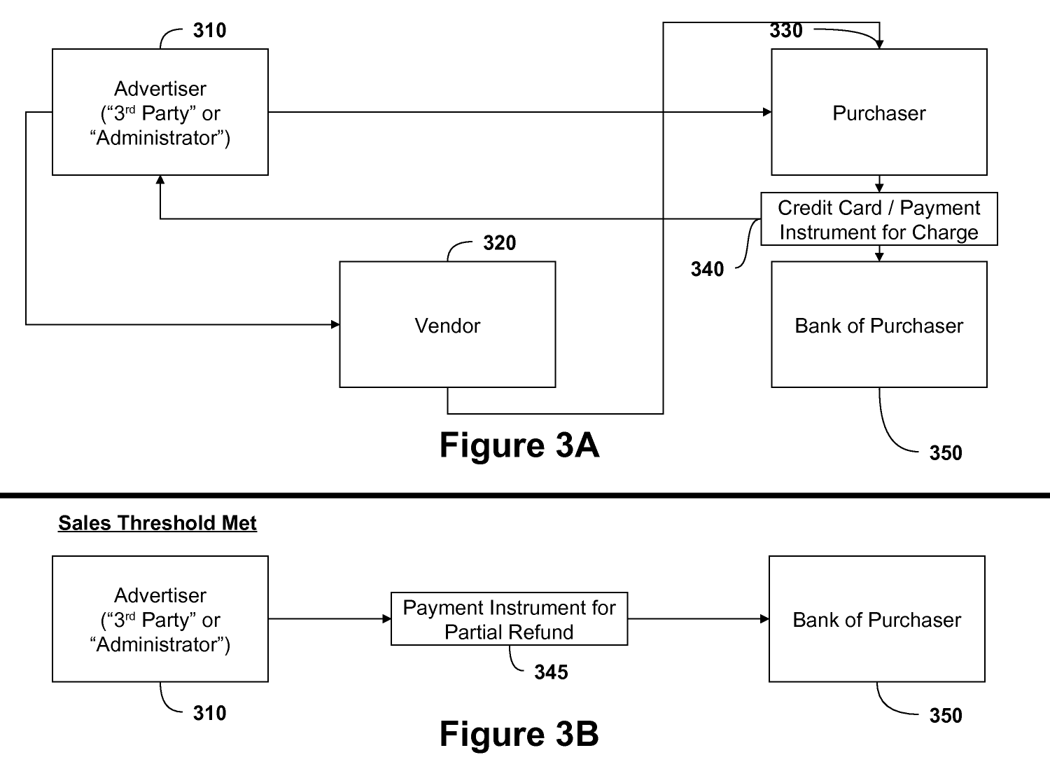

In either of the above cases, once the pre-defined sales threshold is met in step 170, step 180 is carried out, whereby a partial refund is provided to the certified purchasers. The method and devices used to carry out the partial refund will be discussed in greater detail with references to FIGS. 2 and 3.

FIG. 2 shows a flow chart depicting a method of carrying out embodiments of the disclosed technology, including steps of determining which product to use with the method. Box 200 shows various steps which may be taken in embodiments of the disclosed technology to determine which product is selected for use in a partial-refund program. Step 202 shows that votes may be received by users, such as via a web interface or social networking platform on the internet. A vendor may, for example, list various products or simply list its entire inventory on its website or a partner retailer site. Customers may then vote as to which product should be entitled to a partial refund if the requisite number of purchases is made. The refund amount may be tiered. That is, the more votes received, the higher the discount amount, up to a point, all set by the vendor ahead of the voting. The sales threshold may then be sent as a percentage of the number of votes, such as 25%, 50%, 100%, 200%, 500%, or 1000%. That is, if 100 votes are received for a product and the vendor decides to offer the post-payment discount, the requirement for the 100% level would be for 100 people to actually purchase the product and be certified to receive the discount. At the 1000% level, 1000 people would have to purchase the product. Thus, the 100 voters would be inclined to make good on their vote by each recruited, on average, 10 more purchasers and would feel in control of the price. The early purchasers or voters might also receive a greater post-purchase partial refund for their efforts and as a reward. Such purchasers might even be motivated further by receiving the product at a substantial discount, perhaps even below cost, and be “paid” a more substantial amount than later purchasers in the form of the partial refund. Such a voter/purchaser might find that such a system allows him or her to leverage his social network to receive products below cost, or at least, substantially discounted, while also getting a discount for his friends. The vendor is pleased because this system breeds consumer loyalty, in addition to a larger number of sales.

In other ways of choosing a product for use with methods of the disclosed technology, a product might be chosen automatically when inventory is above a pre-defined threshold in step 204, or sales are below a pre-defined threshold in step 206. A vendor might set up such systems to run automatically by pre-defining a post-payment refund program when inventory gets too large for a product and/or sales have dropped below desired levels, in order to move a less popular product or re-popularize a product which is falling out of grace. This may be combined with, or separate from, making a manual selection of an item, in step 208, such as an item selected for a partial refund after sale. That is, in step 210, the item for sale is determined, as well as the potential refund amount if sales pass a given threshold.

Still referring to FIG. 2, in step 220 the partial refund for a product is advertised, with the advertisement comprising information that the partial refund is conditioned on a set number of buyers of the product by a certain date, and/or a given number of buyers requesting (implicitly, such as by voting for the product and being matched as a voter/purchaser; or explicitly, such as by informing a cashier or clicking a button on a vendor website) to receive the partial refund. In step 225, voters from step 202 may be certified as part of an “opt-in” group, that is, a group of purchasers who expressed interest in buying the product and can be identified as being one who purchased the product, or one who pays by credit card may be deemed to have automatically been certified and opted in. In step 230, when receiving a request for the partial refund, a purchaser may be certified at that point by clicking on a website button indicating same, selecting a product for sale from a designated area (of a store, website, catalog) of products which are part of a post-purchase discount program, and so forth. In some cases, a person may select to be part of the program on a website, then go to a store to buy the product, and the workers at the store are unaware that the person is part of such a program. Their credit card number, name, address, and/or identification number (such as when using a store discount card) may be used to verify that a certified potential purchaser has become an actual purchaser and is fit to receive a post-purchase partial refund if the sales threshold is met. In any of these cases, at some point, step 240 is carried out and a product is sold to a requester of same.

Step 245 represents a step carried out in embodiments of the disclosed technology, where a visual display counter showing, at least, advertising of a product for sale with a partial-refund possibility. Other information shown on the counter may include a count of how many more purchases within the opt-in group are necessary for eligibility for the discount (partial refund), quantity of the product sold in the program, number of opt-in users, the partial-refund amount, total dollars saved by purchasers, and the like. This counter may be displayed on a website selling the product, a third party website which advertises or maintains the partial-refund transactions and/or users who become purchasers, or may be a physical counter shown in a store, such as part of a display near the entrance door or a cash register. The display may be viewable outside the store, such as in a mall, as a form of advertising to draw customers in to the store to buy the product.

When the product is sold, in step 240, the purchaser is charged. The charge method depicted in step 250 is a charge on a credit or debit card. However, any payment instrument may be used. One advantage of a credit card payment is that refunds are regularly processed by way of reversing charges on a credit card and by placing a new refund on to the credit card. Jumping to step 270, for purposes of discussing the charges and refunds together, in step 270, a partial refund on a credit card (or through another payment instrument or account) is made only after step 260, where the sales threshold is met or exceeded the amount advertised in step 220 (or set in step 120). If the credit card is charged, then refunding part of the charge takes place after the sales threshold is met. In many cases, the refund will be in the same billing cycle for the purchaser, so the partial refund will appear on the same credit card statement, relieving the purchaser of ever actually paying the full price, unless the sales threshold is not met. The credit card (or debit card) company, in turn, receives a fee for both the initial charge and the partial refund, as these are two different transactions processed on the credit or debit card. The refund may be listed as “triggerback” or “loyalty” points in the form of actual money refunded. Thus, a line on a credit card statement might read: “RETAILER: $200” for the initial charge, and “TRIGGERBACK*RETAILER: (−$50)” for the partial refund, where “RETAILER” is the name of the vendor that appears on the credit card statement, and “TRIGGERBACK” indicates the loyalty dollars refunded back to the credit card, indicating that the purchaser, by being loyal and joining a group purchase with this retailer, got money back once the sales threshold was met. Similarly, when making a purchase, such a loyalty indicator may be displayed, for example, on a cash register screen, on a screen of hand-held wireless device used to make the purchase (such as when making a purchase via near field communication), or the like. Further, such a hand-held wireless device may be loaded with application that is inputted with a store location (either by way of GPS, manual selection by the user, or receiving near field communication data at a terminal within the store) and lists the products for sale in the store where one may earn loyalty points. After receiving such a list of products, a user is deemed to have opted in for the rewards points when making a purchase of such a product.

Similarly, the partial-refund might be processed on a check payment instrument. In this manner, a person pays by check and electronic ACH (automated clearing house), or a return check in the mail is sent to the purchaser for the partial refund. The check may have in the memo line, “loyalty rewards” or the like. Still further, in either of these cases, the vendor may hold on to the full purchase price for 30 days or another period of time to earn interest or invest the money until the partial-refund in processed. Still further, in embodiments of the disclosed technology, the partial refund may be placed on a store debit, credit card, or other in-store account, to be used with further purchases at the store. For purposes of this disclosure, while the money is actually being held by the vendor, this is within the definition of a partial refund to the purchaser since the funds are available for the purchaser to reuse.

Referring back to FIG. 2, when the sales threshold is met, in step 260, as has been described immediately above, step 270 is carried out and a partial refund is sent to each purchaser. If the threshold is not met, then step 280 is carried out, whereby time elapses until either another person becomes a purchaser of the product, or the sale ends without reaching the sales threshold.

FIG. 3A shows a high level block diagram of the relationship between parties and devices used to carry out embodiments of the disclosed technology. An advertiser 310 advertises a partial refund for a product if enough sales are made of the product. The advertiser may be a 3^{rd} party or administrator. That is, the 1^{st} party, in this paradigm, is the vendor, retailer, or actual entity making the sale of the item to the purchaser. The 1^{st} party may be the advertiser (in which case, boxes 310 and 320 represent identical parties) or a 3^{rd} party may provide the advertising, alone, or in addition to the first party vendor 320. The 3^{rd} party, in embodiments of the disclosed technology, manages user accounts related to purchasers and tracks or certifies the users in an opt-in group of users purchasing a product for which one may receive a partial refund if a sales threshold is met, of sales to the certified purchasers. This 3^{rd} party, for example, may have a website (or operate functions on a website integrated into a vendor website) where users vote on products for inclusion in a partial-refund program, or users select a product for which they want to receive a post-payment partial refund (e.g., the users certify themselves via the website and, in embodiments, purchase the item via the 3^{rd} party website or a link to the 1^{st} party website which is tracked between the parties).

For purposes of the claim language, where steps such as “setting,” “receiving,” “selling,” and “determining” are listed, this is defined to include either directly to a purchaser (where applicable) or by way of the 1^{st} or 3^{rd} party. That is, a step of “setting a pre-determined sales threshold for sales of said product to said opt-in group before selling to a purchaser in said opt-in group” may be set by a 1^{st} party (vendor) or 3^{rd} party (advertiser and/or refund processor), but as long as the 1^{st} party and 3^{rd} party are working together in the above-described partial-refund program, both are deemed to be carrying out these steps. Similarly, with regard to other setting, advertising, receiving, selling, and refunding steps, each of the 1^{st} and 3^{rd} party, when acting based on data from the other party to carry out directly or indirectly (via the other party) steps of the claims, is deemed to be carrying out the claimed step itself.

Once the advertiser 310 advertises a product in a partial-refund program, a purchaser 330 is a recipient of such an ad who notifies the advertiser 310 (or vendor 320) through implicit or explicit action that he or she is purchasing the product with a desire to receive the partial refund of a payment, once a sales threshold is met. A payment instrument 340 (such as a credit card) is used to charge the purchaser, and the goods or services (product) are delivered or ordered. The advertiser 310 is notified of this charge and certifies the user into an opt-in group desiring the partial refund for the product, if the user has not been previously certified by methods described with references to FIG. 1 or 2. The vendor 320 is informed of the sale to the purchaser 330 (or made the sale), and the product is delivered to the purchaser 330. Meanwhile, the payment instrument 340 is used to debit or reserve funds from a bank 350 associated with the purchaser.

FIG. 3B shows a high level block diagram of the relationship between parties and devices once a sales threshold is met. The advertiser 310 (which, again, may be the vendor 320 or a 3^{rd} party administrator, such as a payment processor and/or advertiser of partial-refund programs described herein) sends a refund to each purchaser 310 via a payment instrument for a partial refund 345, which directs funds to the bank of the purchaser 350. This may be done by way of payment instrument 340 (a partial refund of the charge made with reference to FIG. 3A, effectively negating part of the first charge, or is via a new processed payment as shown in box 345.

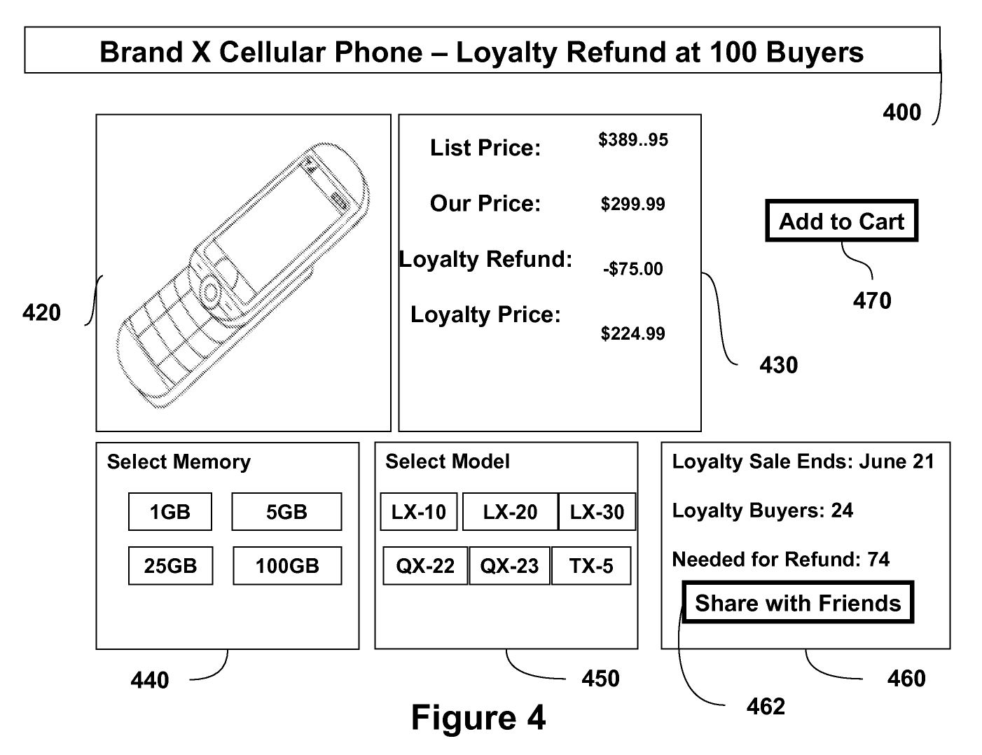

FIG. 4 shows an example of a product being advertised in connection with embodiments of the disclosed technology. It should be understood that this figure is by way of example only and that elements shown in the figure may be exhibited on an in-store monitor or touchscreen, a website/online retail presence, or both. In this case the name of the product and information about a “loyalty refund” or partial refund after purchase are shown in block 400, indicating that a specific cellular phone is being sold and 100 buyers are needed to receive the “loyalty refund.” In block 420, a picture of the device is shown, and in block 430 a list price, the price it is being sold for (how much a buyer is charged when purchasing), a loyalty refund amount (the amount refunded if the sales threshold is met), and loyalty price (price after partial-refund, if applied) are shown. If purchasing via an online retail presence, or in a store using a device to opt-in to the program, a user may “add to cart” 470 or otherwise select a button which indicates that the user is a purchaser who wishes to receive the partial refund. Using a login and password or other authentication scheme of a website, a retailer, vendor, or the like, or simply by then providing a credit card number or other identification information, the person is verified and the refund means (credit card, check in the mail, electronic wire transfer, credit to a store account) are ready to charge and/or receive the partial-refund for the purchased product (which, again, may be any goods or services).

In embodiments of the disclosed technology, only a specific make and model is eligible for the partial-refund after purchase. In other embodiments, a variety of a product or products may be part of the same partial-refund program, sharing a number of buyers. In the example shown in FIG. 4, in this case, the loyalty/partial-refund program includes any opt-in purchasers of the models shown in box 450 having memory amounts shown in box 440.

In box 460 information about the partial-refund is shown. This may, again, be on a display showing a counter, such as in a store itself. The display may include a touchscreen for interactivity and sharing on a social network (such as Facebook, Okrut, or the like), and may include a QR code which is a code readable by a personal digital device, such as a cellular phone or tablet computer which is recognized as a hypertext link. In any of these cases, the person may then share this information with friends. Such information may additionally be shared, or asked to be shared, once a person purchases the item, since it is in their interest to advertise the information to their friends, so that each can receive a partial refund after purchase. A button 462 may be provided to enable a person to share such data easily. In this case, 100 sales are required by June 21^{st} to be eligible for the $75 loyalty refund. Twenty-four sales have taken place and 74 are needed before the deadline, in order for all purchasers that have been certified/opted-in for the loyalty discount to receive the partial-refund.

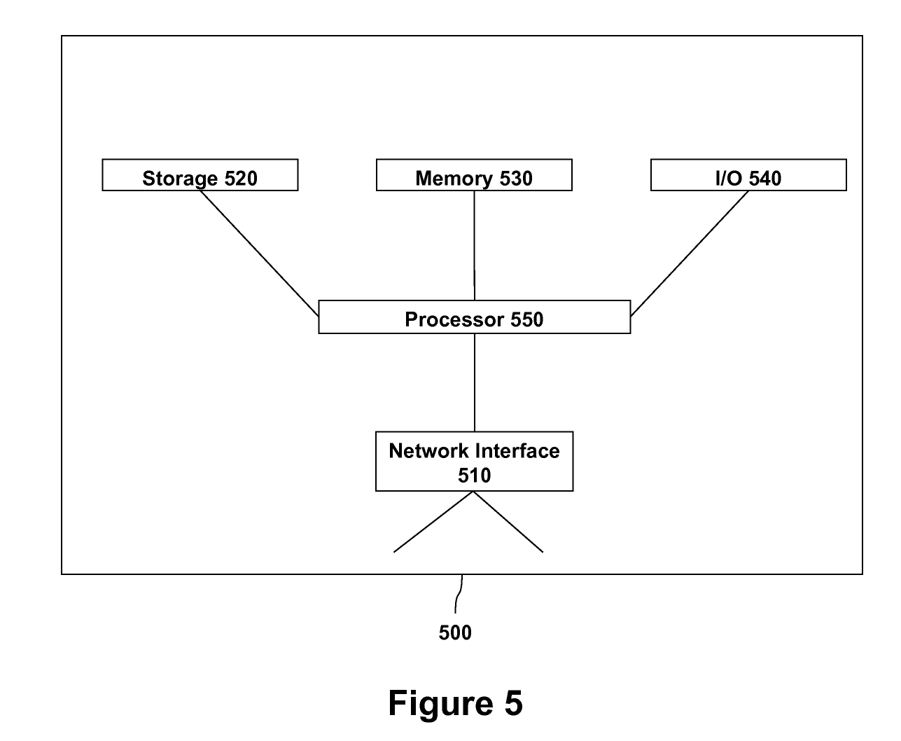

FIG. 5 shows a high-level block diagram of a device that may be used to carry out the disclosed technology. Device 500 comprises a processor 550 that controls the overall operation of the computer by executing the device's program instructions which define such operation. The device's program instructions may be stored in a storage device 520 (e.g., magnetic disk, database) and loaded into memory 530 when execution of the console's program instructions is desired. Thus, the device's operation will be defined by the device's program instructions stored in memory 530 and/or storage 520, and the console will be controlled by processor 550 executing the console's program instructions. A device 500 also includes one or a plurality of input network interfaces for communicating with other devices via a network (e.g., the internet). The device 500 further includes an electrical input interface. A device 500 also includes one or more output network interfaces 510 for communicating with other devices. Device 500 also includes input/output 540 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 4 may be implemented on a device such as is shown in FIG. 5.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A method of issuing a partial refund to each purchaser in an opt-in group of purchasers of a product, comprising the steps of:
setting a pre-determined sales threshold for sales of said product to said opt-in group before selling to a purchaser in said opt-in group;
setting a pre-determined partial refund amount before selling to a purchaser in said opt-in group;
advertising a first purchase price, said sales threshold, and said pre-determined partial refund amount;
receiving a request from and certifying each purchaser into said opt-in group before selling said product to each said purchaser;
selling said product at said first purchase price to a plurality of purchasers;
determining if said pre-determined sales threshold has been met; and
providing said pre-determined partial refund to said plurality of certified purchasers.

2. The method of claim 1, wherein potential purchasers are polled to determine which product is selected for use with said steps of setting and selling.

3. The method of claim 2, wherein said pre-determined partial refund is based on a number of votes in said polling for a said product.

4. The method of claim 2, wherein any potential purchaser in said poll meets said criteria for said certifying.

5. The method of claim 1, wherein said partial refund is in the form of a credit card refund.

6. The method of claim 5, wherein said step of selling is carried out by a first party and said refund is carried out by a third party, said first party paying a fee to said third party for each said refund.

7. The method of claim 1, wherein said sales threshold is limited by sales over a pre-determined period of time.

8. The method of claim 7, wherein said sales threshold is further limited by a fixed quantity of items sold.

9. The method of claim 7, wherein said product includes all products of a model, make, style, or type of service offering.

10. The method of claim 1, wherein a said product is selected for said steps of setting and selling, automatically, when inventory of said product rises above a pre-defined threshold.

11. The method of claim 10, wherein a product is further selected when sales fall below a pre-defined threshold per unit time.

12. An in-store item counter comprising a visual display, wherein:
said visual display exhibits said advertising of claim 1 for at least one said product and further exhibits a count of how many more purchases within said opt-in group are necessary to receive said discount.

13. A method of processing refunds for a vendor of products, comprising the steps of:
advertising a partial refund for a product purchase if a pre-determined threshold of sales is established for said product, wherein said threshold of sales is exhibited as part of said advertising;
certifying each purchaser that purchases said product as being part of a group of purchasers suitable for receiving said partial refund;
receiving information comprising data indicating that said pre-determined threshold of sales has been met; and
issuing said partial refund to each said purchaser in said group of purchasers.

14. The method of claim 13, wherein said partial refund is to a credit card or debit card.

15. The method of claim 14, wherein said partial refund is exhibited on a statement associated with said credit card or debit card as a loyalty credit.

16. The method of claim 13, wherein said certifying is based, at least in part, on matching identifying data of a purchaser provided by said vendor, with identifying data provided to an entity carrying out said method of processing refunds.

17. The method of claim 16, wherein said identifying data comprises a billing address and credit card number of a said purchaser.

18. The method of claim 13, wherein said purchase is non-refundable if said threshold of sales is not reached and the purchaser is part of said group.

19. The method of claim 13, wherein a single non-vendor entity carries out said step of advertising, certifying, receiving, and issuing on behalf of said vendor.

20. The method of claim 13, wherein after said threshold of sales is reached, additional purchasers join said group and are certified up to a pre-determined upper-limit threshold of purchasers in said group.

21. A system of providing partial refunds after purchase, comprising:
receiving data comprising the number of sales of a product to purchasers indicating a desire to receive a partial refund if the number of sales to said purchasers exceeded a pre-determined amount;
determining if said number of sales to said purchasers is above said pre-determined amount;
issuing said partial refund to said purchasers.
